(19) United States
(12) Patent Application Publication
(10) Pub. No.: US 2007/0103431 A1
(43) Pub. Date: May 10, 2007

(54) Handheld tilt-text computing system and method

(76) Inventor: Benjamin Avery Tabatowski-Bush, Northville, MI (US)

Correspondence Address: Robert Powley and Nancy Juette,;Powley & Gibson, P.C., 2nd Floor, 304 Hudson Street, New York, NY, 10013, US

(21) Appl. No.: 11/256,702

(22) Filed: Oct. 24, 2005

(51) Int. Cl. G09G 5/00

(52) U.S. Cl. 345/156

(57) ABSTRACT

A handheld device serves as a general purpose computer with Tilt-Text input and Text-To-Speech (TTS) feedback to the operator. The device can be operated with one hand and accommodates “eyes-free” operation. The Select button is used in conjunction with the X-Y accelerometer to implement a unistroke, Tilt-Text character set for data input with which the user enters letters, numbers, and other symbols into the computer device. Other buttons on the housing are used to implement commands and user functions. Other feature support text input using the accelerometer, including the Virtual Button and Pointer Text approaches.

### FIELD OF THE INVENTION

This invention relates to a handheld electronic device which operates as a general purpose computer, intended to be operated with one hand with “eyes-free” feedback. In particular, the invention focuses on the operation of a Tilt-Text character recognizer as well as other user interface considerations for “eyes-free” operation.

### BACKGROUND INFORMATION

The keyboard and mouse have long been the main devices used to input data into computers. However, such input devices are not amenable for mobile computing owing to their modes of operation and ergonomics. Advances in mobile computing include development of the laptop portable computer and, more recently, small hand-held computers, including for example, Personal Digital Assistants or “PDA”s. Such hand held devices typically, however, have limited processing power and provide, for example, only calendar, contacts, and note-taking applications but may include other applications such as a web browser and media player. Small keyboards and pen-based input systems are most commonly used for user input. PDAs, while compact and allowing for a degree of mobile computing, usually require use of both hands for input—i.e., one to hold the device and another to enter the data—either by, e.g., actuation of keys on a miniature keyboard, or writing with a stylus.

Advances in hand-held devices for data entry have been achieved and include incorporation of accelerometers for position sensing and data input.

For example, one such device provides a handheld apparatus for recognition of writing which utilizes accelerometers to determine the motion of the tip on a writing surface. Buttons are used to switch between operation modes.

Another such device uses a written command device that uses accelerometers with which the user writes commands in the air. The device also has buttons for activating and controlling operation modes.

Yet another known implementation of such improved handheld devices provides a hand-held electronic writing tool which uses an accelerometer for sensing the movement of a tip on a writing surface and does not have any buttons.

The foregoing examples of prior art devices are similar in their hardware implementation in that they include apparent use of accelerometers connected to a processor which implements some type of character recognition functionality.

Such technologies are discussed for example, in U.S. Pat. Nos. 5,434,371 and 6,456,749 and U.S. Patent Application Publication Number 2001/0024193A1.

Typically, these prior art devices are manipulated “in the air”—i.e., there is no writing surface which needs to be contacted (e.g., as described above). These prior art devices however, exhibit certain shortcomings. For example, such prior art devices lack a method of disambiguating the start and end of characters. Therefore, it is necessary to implement continuous character recognition, which is very computationally intensive requiring enhanced processing capability, and the processing power required is not readily available in such a small ergonomic device powered by batteries, much less so in a package which can be held and operated unobtrusively in one hand.

Moreover, the prior art does not provide a method for the user to operate the computing device in an intuitive, “eyes-free” fashion. Conventional computing technology requires the use of a monitor or display for a visual mode of feedback. This is limiting and inconvenient for mobile computing.

### SUMMARY OF THE INVENTION

The present invention overcomes the above mentioned problems and other limitations of the prior art and further provides such advancements in the state of the relevant art by, inter alia, providing a hand held electronic apparatus that allows for eyes-free operation with one hand.

In accordance with an aspect of the present invention, an apparatus comprises, in an illustrative implementation, a compact, self-contained computer which can be operated intuitively with one hand.

In an illustrative embodiment, the present invention includes a Select button as well as other buttons, and electronic circuits that include an X-Y accelerometer that measures tilt, a Mixed-Signal Array with a built-in processor that supports programmable analog functionality as well as conventional digital processor functions, containing RAM and Flash memory with an Operating System and Application Software. Other circuits may include a RS232 serial interface, a wireless Bluetooth interface, and/or a Voice Chip for operator feedback. An expansion board interface in the housing can be included to allow for the addition of hardware to the device. In the illustrative embodiment, the connection of a standard 2.5 mm cellphone handsfree set (microphone plus speaker) is supported. Alternatively, connection to a Bluetooth cellphone handsfree component is supported through the Bluetooth radio interface. A power source such as a battery or an external power supply can used to power these electronics.

For purposes of illustrative explanation, aspects and features of this invention include:
Implementation of a unistroke character recognizer used in conjunction with Select Button or Virtual Button, as well as an alternate Pointer Text method.
Implementation of an “eyes-free” user interface which incorporates the text input innovations previously mentioned, integrated with an audible Text-To-Speech feedback system and other user interface Buttons that support one-handed, no-look operation.
Networking with other computer devices via an onboard expansion interface, as well as offboard networking via RS232 and Bluetooth.

While other implementations can be achieved by following the teachings of the present invention described herein, two illustrative methods for inputting text according to the present invention are proposed.

The first is a unistroke character recognizer, implemented with an X-Y accelerometer and a physical Select Button on the housing or a Virtual Button, implemented as a software function applied to the accelerometer output. The recognizer software operates by monitoring the accelerometer data over time, bounded in time between a start and stop time which is defined by the Select Button or Virtual Button. The recognizer software reduces the accelerometer data by updating key parameters as it monitors the accelerometer data from Start to Stop. The parameters chosen allow a unique Gesture to be assigned to the user input, which is translated to a character, a series of characters, or a symbol based on a Shift State variable and the Application Software.

The second method for inputting text is the Pointer Text approach which is, in terms of implementation and use, simpler and requires less training for the operator. In one implementation, the software presumes a Table of characters, series of characters (words,) or symbols in the same X-Y space as is defined by the output of the X-Y accelerometer. User selection of a Shift State and interaction with Application Software defines the exact contents of this Table. Under this scheme, the number of entries and the shape of this table are adjustable. The user prepositions the X-Y accelerometer to where they think the character is located, and presses the Select Button. Text-To-Speech (TTS) Voice Chip feedback provides audible feedback for the user to refine the choice of Text. When they release the Select button, the character/text/symbol is chosen.

The integrated TTS system works in conjunction with the character recognizer and other input buttons to provide a user interface. There are certain common tasks which a user performs such as list entry, list navigation, and generalized data entry in which the user interface is quite different from a typical Graphical User Interface (GUI) as would be found on a conventional computer. Information on the specifics of this TTS feedback for common tasks is discussed in further detail in the Detailed Description which follows.

The usefulness of the present invention is enhanced by networking capability. Specific provisions are made on the Expansion Board interface to accommodate connection to local additional computing devices. The present invention allows flexible expansion through a Serial Peripheral Interconnect (SPI) bus, along with other general-purpose expansion signals. Connection with other separate computing devices or networks is accomplished in one illustrative embodiment, with a TTL UART and a RS232 UART interface on a connector made available on the housing. A Bluetooth radio allows for wireless networking, as well as audio connectivity via a PCM interface. More detail is provided hereinbelow on the special considerations for maintaining the one-handed, “eyes-free” operation while utilizing these networking features.

It will be appreciated by those skilled in the art that the foregoing brief description and the following detailed description are exemplary and explanatory of this invention, and are not intended to be restrictive thereof or limiting of the advantages which can be achieved by this invention. Thus, the accompanying drawings, referred to herein and constituting a part hereof, illustrate preferred embodiments of this invention, and, together with the detailed description, serve to explain the principles of this invention.

### BRIEF DESCRIPTION OF THE DRAWINGS

Additional aspects, features, and advantages of the invention, both as to its structure and operation, will be understood and will become more readily apparent when the invention is considered in the light of the following description of illustrative embodiments made in conjunction with the accompanying drawings, wherein:

FIG. 1 is an isometric view of an illustrative embodiment of a handheld device according to the present invention;

FIG. 2 is an exploded view of the illustrative embodiment of the handheld device of FIG. 1;

FIG. 3 is a block diagram of a computer system according to an illustrative embodiment of the present invention;

FIG. 4 is an illustrative implementation of a table of character gestures associated with the unistroke character recognizer implemented in the present invention;

FIGS. 5A and B is a table of numeric parameters associated with the unistroke recognizer implemented in an illustrative embodiment of the invention;

FIG. 5C is a table of normalized accelerometer output for use with the unistroke recognizer implemented in an illustrative embodiment of the invention;

FIG. 6 is a flow chart of the Shift State Flow, illustrating the state diagram for the selection of lowercase, uppercase, numbers, and punctuation for generated characters according to an illustrative implementation of the present invention;

FIG. 7 is an array illustrating an uppercase alphabet for use with the Pointer Text character selector implemented in an illustrative embodiment of the invention;

FIG. 8 is an array illustrating a lowercase alphabet for use with the Pointer Text character selector implemented in an illustrative embodiment of the invention;

FIG. 9 is an array illustrating a number table for use with the Pointer Text character selector implemented in an illustrative embodiment of the invention;

FIG. 10 is an array illustrating a punctuation table for use with the Pointer Text character selector implemented in an illustrative embodiment of the invention;

FIG. 11 is an array illustrating one menu for use with the Pointer Text menu system implemented in an illustrative embodiment of the invention, referred to as Pointer Menu 1; and

FIG. 12 is an array illustrating another menu for use with the Pointer Text menu system implemented in an illustrative embodiment of the invention, referred to as SPR List Menu; and

FIG. 13 is an array illustrating another menu for use with the Pointer Text menu system implemented in an illustrative embodiment of the invention, referred to as Field List Menu; and

FIG. 14 is an array illustrating another menu for use with the Pointer Text menu system implemented in an illustrative embodiment of the invention, referred to as Word List Menu;

FIG. 15 is an array illustrating the Button Menus indicating example functions which can be associated with buttons in an illustrative embodiment of the invention; and

FIG. 16 is a menu state flow diagram indicating different menus available in the in an illustrative embodiment of the SPR application of the present invention.

### DETAILED DESCRIPTION OF EMBODIMENTS OF THE INVENTION

The present invention provides an apparatus which comprises, in an illustrative implementation, a compact, self-contained computer which can be operated intuitively with one hand.

A preferred illustrative embodiment will now be described to assist in understanding the present invention.

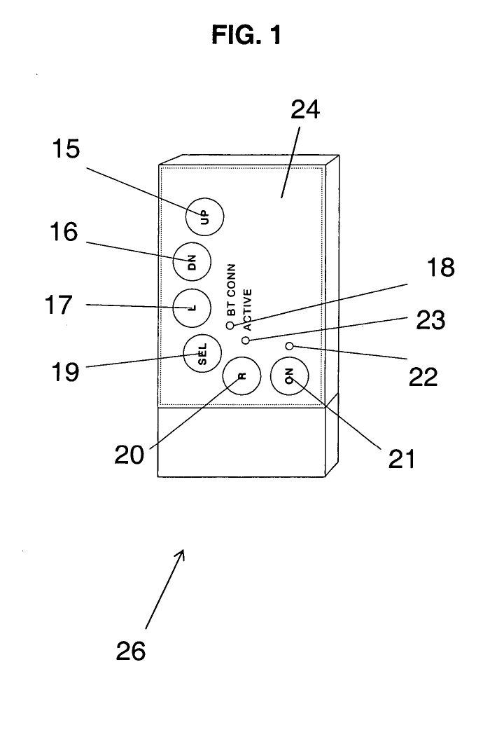

With reference to FIGS. 1-3, the present invention, in the exemplary preferred embodiment, is configured in an ergonomic, hand-held device 26.

As will be discussed in detail with respect to FIGS. 1-3, the device will typically have provisions for functional, user activated switches and various electronic circuits that allow for data input and processing. As explained in further detail infra, these circuits include an X-Y accelerometer that measures tilt, a Mixed-Signal Array with a built-in processor that supports programmable analog functionality as well as conventional digital processor functions, containing RAM and Flash memory with an Operating System and Application Software. Other circuits may include a RS232 serial interface, a wireless Bluetooth interface, and/or a Voice Chip for operator feedback. An expansion board interface in the housing can be included to allow for the addition of hardware to the device. In the illustrative embodiment, the connection of a standard 2.5 mm cellphone handsfree set (microphone plus speaker) is supported. Alternatively, connection to a Bluetooth cellphone handsfree component is supported through the Bluetooth radio interface. A power source such as a battery or an external power supply can used to power these electronics.

For purposes of illustrative explanation and as will be explained in detail below with reference to the accompanying drawings, more salient aspects of this invention include:
Implementation of a unistroke character recognizer used in conjunction with Select Button or Virtual Button, as well as an alternate Pointer Text method.
Implementation of an “eyes-free” user interface which incorporates the text input innovations previously mentioned, integrated with an audible Text-To-Speech feedback system and other user interface Buttons that support one-handed, no-look operation.
Networking with other computer devices via an onboard expansion interface, as well as offboard networking via RS232 and Bluetooth.

With reference to FIG. 1, shown is an isometric view of an illustrative embodiment of a handheld device 26 according to the present invention.

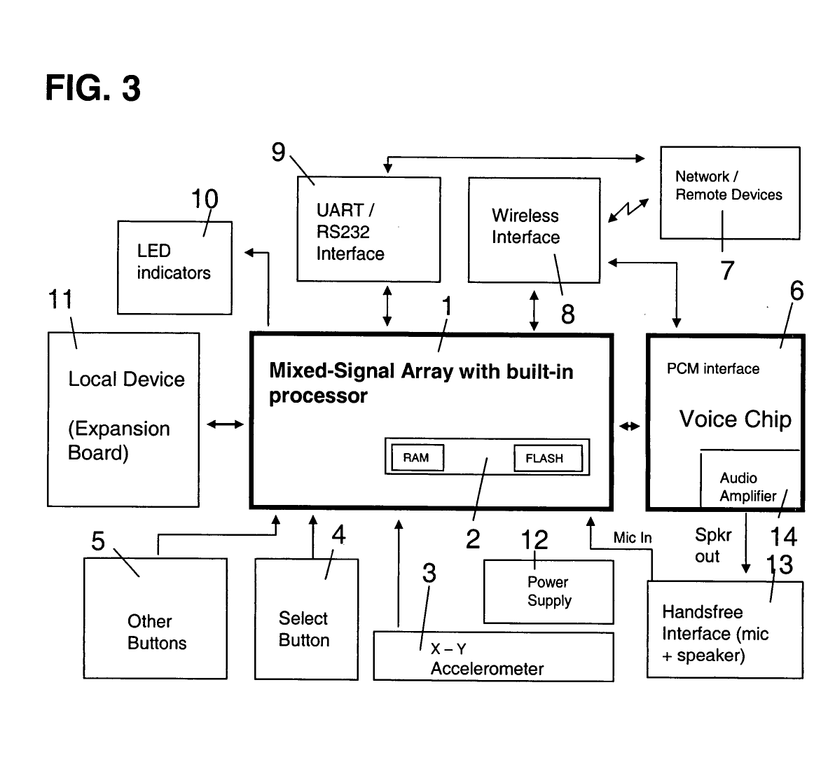

While any number of Buttons/switches may be provided on the device 26 for user input, in this embodiment, 6 soft (i.e., programmable) buttons 15, 16, 17, 19, 20, and 21 are provided. That is, the Operating System (see discussion below with respect to FIG. 3) has the capability of re-assigning functions to the different buttons; and certain Application Software (see discussion below with respect to FIG. 3) may also assign functions to the given buttons. Certain buttons are specified for particular assigned functions which will be described.

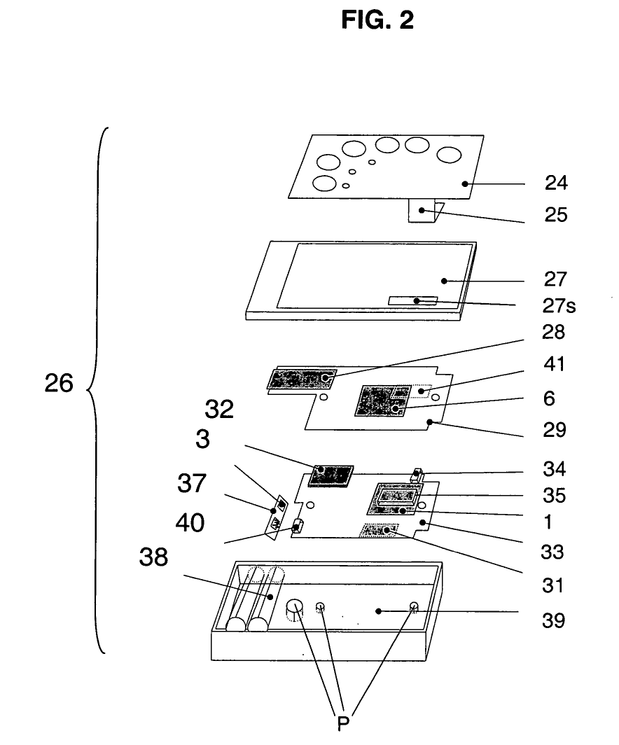

LED indicators may also be provided on the device 26. Particularly, for the preferred embodiment, there is an ON LED 22 which illuminates when the (device) power is turned on, an Active LED 23 which is under Application Software control, and a Bluetooth Connected (BT CONN) LED 18 which provides visual indication when the Bluetooth Radio 28 (FIG. 2) is connected to another Bluetooth device. Other LED indicators, more or less in number, may be provided.

FIG. 2 is an exploded view of the illustrative embodiment of the handheld device 26 of FIG. 1.

Buttons/switches and LEDs are implemented on a keyboard 24, which connects to a main board 33 via a flex cable 25. There is a housing top 27 which has a recessed portion to house the keyboard matte and a slot 27s for the flex cable. The main board 33 holds processor 1, as well as a 15-way connector 32 for connection to, e.g., external systems. The main board 33 has a connector 31 which accepts the flex cable 25. Main board 33 also has a connector 35 for connection to option board 29. Main board 33 also has an 8-way connector 40 for connecting to Accel board 37. Main board 33 additionally has a 2.5 mm connector 34 for a wired hands-free connection. Housing bottom 39 holds batteries 38 and has mounting provisions P for all boards.

Option board 29 holds Voice Chip 6 and Bluetooth Radio 28. The inter-board connector 31 for the main board is used for wired connection to the rest of the product. The Accel board 37 holds an X-Y Accelerometer 3 in such a way so that when a user holds the computer product 26 in their hand with the major axis pointing toward the center of the earth (optimal rest position,) the Accelerometer 3 is parallel to the surface of the earth, which is desired for proper sensitivity. The device is operable in any position, although optimal function is achieved with the aforementioned orientation. As will be understood by those of ordinary skill in the art, mathematical compensation for any deviation from the optimal initial orientation can be applied.

The X-Y accelerometer 3 is used for data input into the computing system of device 26. The accelerometer may be an analog device with two outputs, X and Y. Different embodiments of the invention allow for X-Y accelerometers with different methods (e.g. serial interface, etc.) of transferring the X-Y data to the processor 1. In the preferred embodiment, the accelerometer presents 2 voltages to the processor 1, which represent a tilt in the X axis and a tilt in the Y axis. Accelerometer output is proportional to the acceleration placed upon it, but the varying tilt angles of the X-Y accelerometer 3 causes a differing amount of acceleration from the gravity vector to be applied to the accelerometer sensor element in accelerometer 3, with the precise output voltages for X and Y determined by a tilt angle X and a tilt angle Y with respect to the gravity vector.

As indicated above, this X-Y accelerometer 3 may be mounted on a circuit board 37 which causes the accelerometer 3 to be parallel to the surface of the earth in the “ready” position of the device 26. It should also be so positioned in order to achieve the proper sensitivity of the accelerometer 3 over the operating range as the user tilts the computer device 26 around its center point.

As will be explained in detail, data is input by tilting the computer device 26 in a particular fashion or sequence. While others may be devised as appropriate for a given implementation of the present invention, two illustrative methods of capturing data using this accelerometer 3 are described. One is a Unistroke recognizer method. The other is referred to as the Pointer Text method. Both methods depend on the user to manipulate (i.e., tilt) the computer device 26 while either actuating the select button 21 or utilizing the Virtual Button technique, which will be described in turn.

The Unistroke character recognizer method of data input depends on the user to manipulate the computer device 26 like a pen “in the air,” meaning that the user tilts the device in a series of motions to create motions which will be recognized as characters—i.e., letters, numbers, symbols, etc. It should be understood that the X-Y accelerometer 3 used here to measure tilt, will not respond to translation (lateral movement.) Therefore, all of the “action” in creating unistroke characters is in the tilting.

FIG. 3 is a block diagram of an illustrative preferred embodiment of the present invention.

A Mixed Signal Array with built-in processor 1 is provided. This processor may be any one of many such known devices, such as one of the Programmable System-on-Chip (“PSoC™”) family of such devices manufactured by Cypress Corporation, San Jose, Calif. Processor 1 contains built-in Memory 2, which can include RAM and Flash memory, that may be used to store instructions for the operation of the device (e.g., operating system, application software, etc.), as well as to store data. As is known, the Flash memory works in a non-volatile fashion and the RAM memory temporarily stores data. That is, Flash memory will retain the stored information even when power is removed (i.e., the device is turned off) and RAM memory stores transient information only while power is applied and all such data is lost when power is removed.

Wireless Interface 8 (for example, to Bluetooth Radio 28, FIG. 2) can be used to network with other compatible computer devices. A local computing device or other add-on circuitry can be applied through the Expansion Board 11. This could be implemented for example with a Hirose connector 35. As well, the PCM (Pulse Code Modulation) interface from the Wireless Interface (Bluetooth Radio) 8 is connected to the Voice Chip 6, which has an Audio Amplifier 14 that is connected to a 2.5 mm Handsfree Interface 13. With this construct, it is possible to utilize either a wired 2.5 mm Handsfree for Audio Text-To-Speech (TTS) feedback, or a Bluetooth handsfree. A microphone input is brought in from either handsfree for use in Application Software. ASCII text fed to the Voice Chip 6, where implemented, can be vocalized to the handsfree device via Handsfree Interface 13 or Wireless Interface 8.

Power Supply 12 can be run on batteries 38 in the device 26 (FIG. 2) or from an external power supply (not shown) applied, e.g., through the 15-way connector 32. Either Alkaline batteries or Rechargeable (NiMH) batteries are preferred and supported. For rechargeable batteries, a NiMH trickle charger, associated with a supply connected through the 15-way connector 32, is provided. Several built-in power supply circuits (not shown) such as a linear regulator and a boost-mode Switch Mode Power Supply (SMPS,) with control logic associated with the On switch 21, and a Hold_Power circuit from the processor 1 are utilized. The Hold_Power circuit allows the processor 1 to keep the Power Supply on as long as desired, or to turn the Power Supply off when the user requests it.

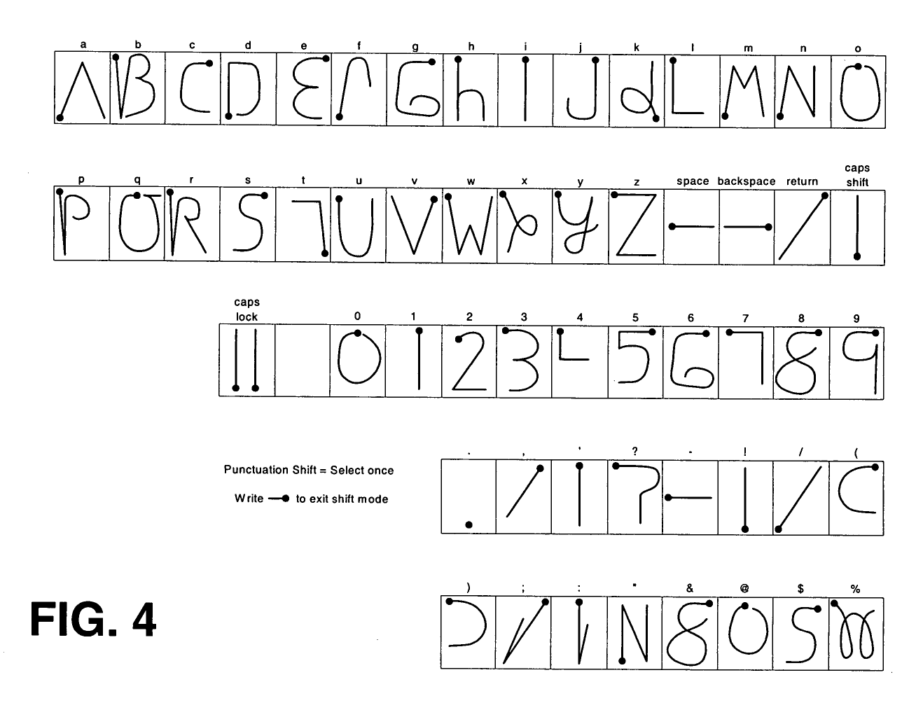

FIG. 4 illustrates an embodiment of a series of Unistroke characters to implement letters, numbers, punctuation marks, and some control characters. The computer device 26 is held in a users hand, with the center point of the device held in a constant position. The characters are created as per the chart in FIG. 4 by a tilting motion. The gestures shown in FIG. 4 represent a 2 dimensional mapping of motions which occur in 3 dimensional space. Each character shown is 1 or more connected arcs which are represented for purposes of illustration by the 2 dimensional characters shown as will be understood by those of ordinary skill.

The processor 1 uses its built in Mixed Signal Array to implement an Analog to Digital converter (A/D) which takes the X,Y voltages from the accelerometer 3 and digitizes them into 2 binary numbers at a given moment in time. These 2 binary numbers, which represent the X and Y tilt, vary with time as the user creates different characters from the chart in FIG. 4. The Operating System may sample the X and Y voltages periodically, so as to create a stream of data which is a digital representation of a character. The task of the Unistroke character recognizer is to convert this stream of digital data into discrete, recognized characters.

Central to the function of the Unistroke character recognizer is that the Operating System, which performs the recognition, be given a start location and a stop location reference in the stream of X, Y data coming from the accelerometer 3. This can be done in any suitable manner, but for purposes of illustration, two are described: bounding through utilization of a Select button 21 or through use of a Virtual Button. The task of the Select button 21 or the Virtual Button is to bound the stream of X, Y data with a start and a stop, so that recognition can be performed just on the bounded set of data.

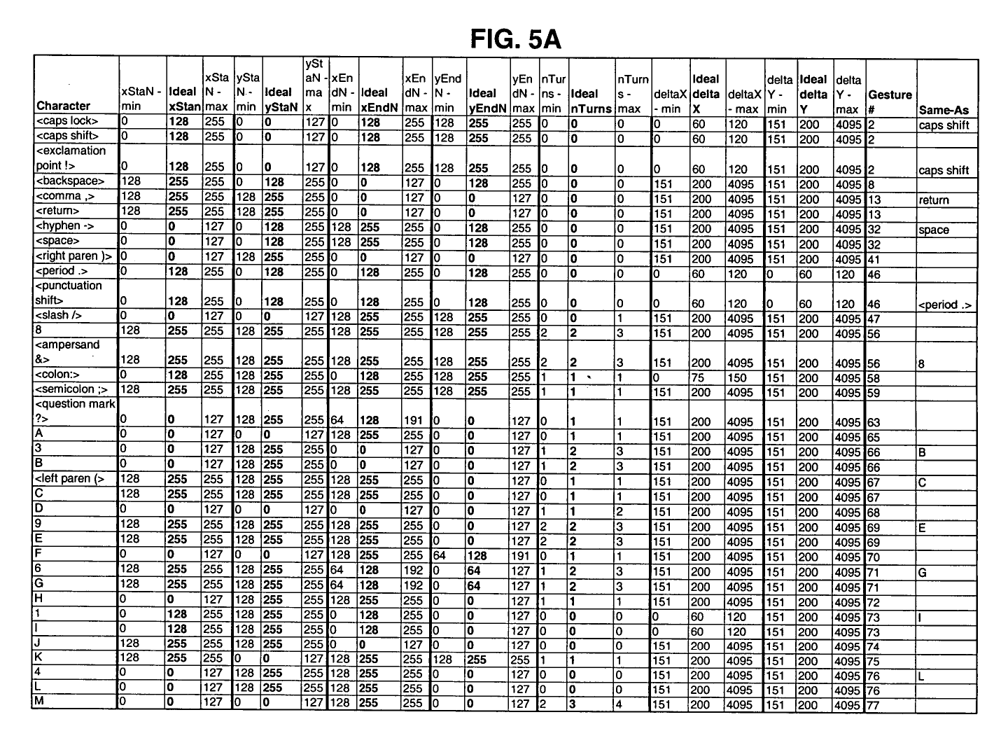

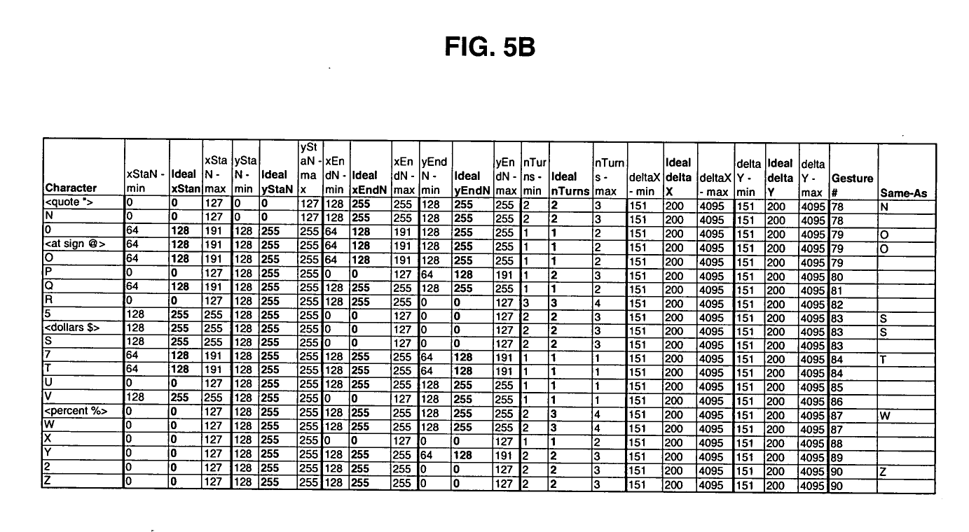

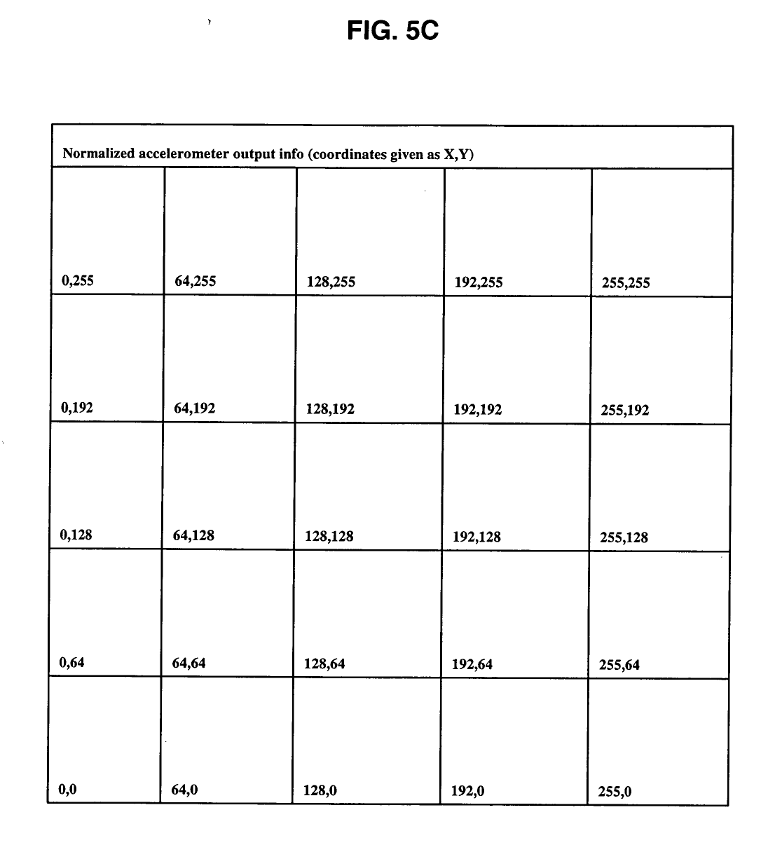

For an embodiment in which a Select button 21 is utilized, the character start position (indicated by a heavy dot in the characters of FIG. 5) corresponds to the X-Y tilt of the device 26 with respect to the gravity vector. That means that the user prepositions the device 26 by tilting so that it is pointing in the direction of the start position as given in FIG. 4, and then depresses the Select button 21. The user continues to hold the Select button 21, maintaining the centerpoint of the device 26 in a fixed position, while tracing out the shape of (or “describing”) the character as given in FIG. 4 “in the air.” When the character has been described, and the end position as given in FIG. 4 has been reached, the user releases the Select button 21. Select button 21 thus delimits the character gesture.

In an alternate embodiment—the Virtual Button embodiment—a character recognizer algorithm can be used which does not utilize the Select button 21, or any other button, to accomplish the bounding of start and finish of the character. Yet, there still is a means for the user to communicate the start and finish of the character to the recognizer algorithm. In this Virtual button approach, the user gives the device 26 a quick shake before starting a character (from FIG. 4), and a quick shake immediately after completing the character gesture. The respective shaking motions before and after the gesture can be resolved respectively as the start and stop bounding. For example, the quick shaking motion can be easily quantified by measuring the “distance” in X-Y A/D count space between successive X-Y pair samples in time. In illustrative implementation, an X-Y “location” is recorded at a predetermined interval, e.g., every 10 milliseconds. To compute the distance between xLast, yLast and xCurrent, yCurrent (2 successive X,Y pairs in time,) calculation is performed as follows:

Successive_Distance=SQRT((xCurrent−xLast)ˆ2+(yCurrent−yLast)ˆ2)

(where SQRT is the Square Root function).

Note that this is not a physical distance, but a computed distance in X, Y A/D count space. When a user is creating characters according e.g., to FIG. 4, it takes about 1 second to create a complete character, and this Successive_Distance is very low (e.g., below 10.) A threshold value is defined, Shake_Value, such that if at any moment when Successive_Distance is computed and Successive_Distance>Shake_Value, the Operating System determines that a Virtual Button event has occurred. A shake will take, on the order of e.g., 300 mS or so to complete, so the Operating System will not consider more than one Virtual Button event occurring in a 300 mS window.

Another important aspect to the timing of Virtual Button events is in distinguishing a Virtual Button Start event from a Virtual Button Finish event, which indicates the start and finish of a character gesture as in FIG. 4, respectively. It can be defined that any character from FIG. 4 must take no more than a predetermined amount of time, e.g., 2 seconds, from the Virtual Button Start event to the Virtual Button End event. To this end, a Virtual_Button_State variable is defined, which is initially OFF when the device 26 starts the character recognizer algorithm. Upon receiving the first Virtual Button event, the character recognizer algorithm observes that the Virtual_Button_State is OFF and considers the event a Virtual Button Start event. The character recognizer algorithm reads the Accelerometer 3 A/D values at a predetermined interval, e.g., every 10 mS, after the Virtual Button Start event. This algorithm must see another Virtual Button event within a predetermined event window, e.g., 2 seconds, of the Virtual Button Start event. If the algorithm detects a Virtual Button event in this time period window, the algorithm observes that the Virtual_Button_State is ON and so considers the event a subsequent event and consequently, a Virtual Button End event. However, if no subsequent Virtual Button event happens in the event window, then the character recognizer algorithm resets the Virtual_Button_State back to OFF and treats it as if no character was created.

In either embodiment (Select button 21 or Virtual Button) the Unistroke character recognizer receives a stream of X, Y pairs from the Accelerometer 3 via the A/D converter implement in 1, at a predefined period of e.g., 10 milliseconds, which allows sufficient resolution to distinguish between the salient, distinguishing features of each character in FIG. 4. The Select button 21 or Virtual Button events as utilized to obtain the start X-Y values and end X-Y values; all X-Y values in between are considered part of the same character.

An illustrative method of performing the character recognition of this Unistroke recognizer will now be discussed. In the illustrative method, the processor 1, in executing the Operating System, creates an array of registers which track key parameters of the character currently being created by the user. The key parameters are implemented by 16-bit registers, called: xStart, yStart, xEnd, yEnd, xMin, yMin, xMax, yMax, xLocSt, yLocSt, xCur, yCur, nTurns, curLength, maxLength, deltaX, deltaY, xStaN, xEndN, yStaN, and yEndN.

When the user initially presses the Select button 21, or immediately after the Virtual Button Start event occurs, then the following occur, in the sequence given:

Variable Initialization;
xCur is set to the initial Accelerometer 3 X reading, and yCur is set to the initial Accelerometer 3 Y reading,

Register Array Initialization;
xEnd, yEnd, xMax, yMax, nTurns, curLength, maxLength are set to 0x00.
xMin, yMin are set to 4095.

The algorithm updates the array appropriately for the first X, Y pair.

xCur=> xStart
xCur=> XLocSt
yCur=> yStart
yCur=> yLocSt

The algorithm updates the min's and max's.

If (xCur > xMax)then (xCur => xMax)
If (yCur > yMax) then (yCur => yMax)
If (xCur < xMin) then (xCur => xMin)
If (yCur < yMin) then (yCur => yMin)

After the Select button 21 or the Virtual Button Start event, the recognizer algorithm will receive a stream of X, Y values from the Accelerometer 3, e.g., every 10 mS. Each time that this happens, the register array is updated as follows:

```
*X=> xCur; Y=> yCur
*Update the min's and max's.
If (xCur > xMax)then (xCur => xMax)
If (yCur > yMax) then (yCur => yMax)
If (xCur < xMin) then (xCur => xMin)
If (yCur < yMin) then (yCur => yMin)
*Compute curLength,
curLength = SQRT[ (Xcur− XLocSt)’+ (Ycur−YLocSt)’]
If Curlength + THRESH1 < maxLength, then
{
    xCur => xLocSt;
    yCur => yLocSt;
    xCur => xT[nTurns];
    yCur => yT[nTurns];
    nTurns++;
}
Else { curLength => maxLength; }
THRESH1 is a calibratable parameter.
```

This section of pseudocode illustrates an important concept, that of nTurns (“Number of Turns.) Looking ahead to the way the recognizer actually distinguishes between characters, FIG. 5A and FIG. 5B provide a tabled lookup of Gesture Numbers versus the register values that are being defined. Note that nTurns is a column on the table which assists in distinguishing between similar characters. Referring to FIG. 4, an example of this would be between the character “a”, which starts in the bottom left and ends in the bottom right. The character “m” also starts in the bottom left and ends in the bottom right. The parameter that distinguishes between these 2 characters is the nTurns, which can be confirmed by comparing the lines for Gesture #65 (A) in FIG. 5A, and Gesture #77 (M) in FIG. 5A. All of the columns are the same between these 2 gestures, with the exception of the columns related to nTurns.

There is an additional circumstance that leads to the register array getting updates. That is at the moment after the Select button 21 is released, or after a Virtual Button End event, as previously described. Under those circumstances, the X,Y pair of interest is the last valid A/D reading of the Accelerometer 3. Using the last valid reading for X and Y,

X=> xCur
Y=> yCur
X=>xEnd
Y=>yEnd
*Update the min's and max's.
If (xCur > xMax) then (xCur => xMax)
If (yCur > yMax) then (yCur => yMax)
If (xCur < xMin) then (xCur => xMin)
If (yCur < yMin) then (yCur => yMin)
*The delta's are calculated.
deltaX = xMax − xMin;
deltaY = yMax − yMin;
The following steps normalize the data to the
range [0-255] for both X and Y.
if deltaX = 0 then 128=> xStaN; 128=> xEndN; else
xStaN = [(xStart − xMin) / deltaX] * 255 ;
xEndN = [(xEnd − xMin) / deltaX] * 255;
if deltaY = 0 then 128=> yStaN; 128=>yEndN; else
yStaN = [(yStart − yMin) / deltaY] * 255;
yEndN = [(yEnd − yMin) / deltaY] * 255;

The final normalization step is performed after the limits xMin, xMax, yMin, and yMax are known (after a character is completed.) Normalization means that all of the points of interest are scaled to the uniform range of 0-255 for both X and Y, as seen in FIG. 5C. This is useful for performing character recognition. The formulas given above provide normalized values for xStaN, xEndN, yStaN, and yEndN. These values now lie on the normalize accelerometer output chart as in FIG. 5C. With this, it does not matter how large or small a user forms a particular character; the output will be normalized to a unit size regardless. However, there are some parameters that do not get normalized which appear in the recognizer table FIG. 5A and FIG. 5B, namely deltaX and deltaY. Generally speaking, these non-normalized values deltaX and deltaY in FIG. 5A and FIG. 5B are used to recognize characters such as horizontal or vertical lines. A good example for understanding is to examine the “i” character and the “return” character from FIG. 4. Notice that a key difference is that the “return” character has a distinctive slope running from the top right to the bottom left, whereas the “i” is substantially vertical. However, when a character is normalized, it scales it in both X and Y so that whatever the actual width of the character, it squeezes or stretches it so that it fits into a normalized unit width as in FIG. 5C. Of course, as the user forms the “i” character, there will be some slight deviation from a perfect vertical line. When normalized, this slight deviation will lead to the normalized version of the formed “i” character which could look exactly like the “return” character. The (non-normalized) deltaX parameter will be much different, which allows the recognizer to distinguish between the two.

After the final updates given to the register array, the character recognizer routine has all the information it needs in order to perform a character recognition. The time-ordered stream of Accelerometer 3 X, Y data has been reduced to a small array of registers which have captured the essential parameters of the recorded data. The algorithm that interprets the Register Array into a Gesture Number will now be discussed. Referring to FIG. 5A and FIG. 5B. The table is organized by characters (gestures) in the rows and limits in the columns. This information is converted into a lookup table in Flash memory.

Note that the following parameters are limit-checked against values in FIG. 5A and FIG. 5B:
xStaN
yStaN
xEndN
yEndN . . . Normalized Values
nTurns
deltaX
deltaY . . . Not Normalized Values

For each of these values, FIG. 5A and FIG. 5B provides a Min and a Max value allowable for each parameter. The idea is that for a row (which is a Character or Gesture) to Pass, each of these given parameters must fall between the given Min and Max in the table. An Ideal value is given for understanding, but is not used in the calculations.

The following provides a description of implementation of the algorithm that processes a complete register array into a Gesture Number, as is illustrated in FIG. 5A and FIG. 5B. Given a set of parameters to be checked, the following process is performed.

Start with the first row (the first gesture to be checked.) Starting with the first (leftmost) column, compare the given parameter against the limits. If the parameter passes (falls between the Min and the Max,) continue checking the other parameters in the same row. If at any point a parameter fails (is less than the Min or is greater than the Max,) that Gesture is rejected and the algorithm moves onto the next row. If all parameters for a row Pass, then the input is judged to be the Gesture that's given in that row. The algorithm only returns one Gesture Number, even if there would be a match to multiple lines in FIG. 5A or FIG. 5B. The algorithm returns 0x00 if there are no matches.

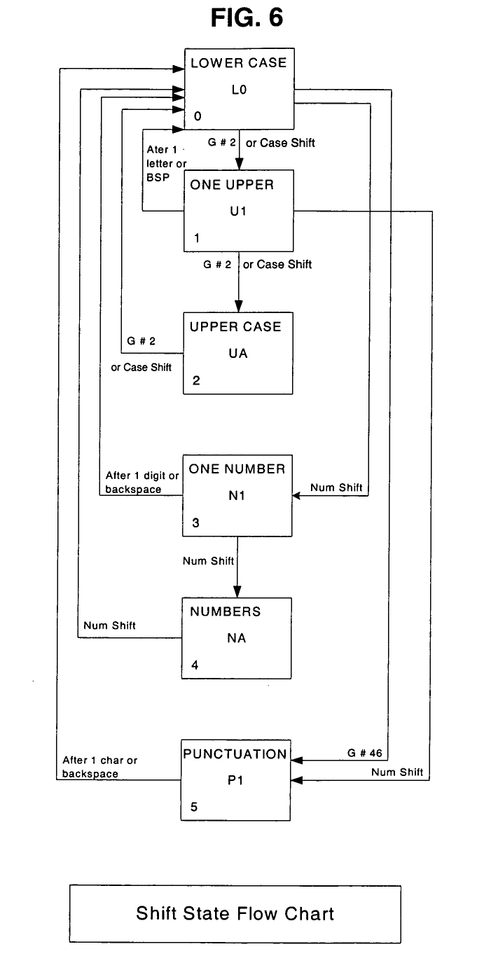

There is a difference between a Gesture Number as indicated in FIG. 5A or FIG. 5B and an American Standard Code for Information Interchange (ASCII) character. An examination of FIG. 4 reveals that several characters—for instance, o, O, 0 and @ from FIG. 4, all map to the same Gesture Number (79) on FIG. 5A. The difference between such characters lies in something called the Shift State. For the examples of o, O, 0, and @ with Gesture#79, the Shift State variable allows the character recognizer to choose the right one. In broad terms, the Shift State indicates whether the character is alphabetical and is uppercase or lowercase, or if the character is numerical or punctuation. The Gesture Number can be resolved to a specific ASCII character by maintaining a Shift State variable as illustrated in FIG. 6. This flow chart assumes that the recognizer starts out in a Lowercase (LO) state. It can advance to One Upper (U1), which means that one uppercase letter will be generated and then the shift state goes back to LO (see boxes 0 and 1 in FIG. 6.) It advance to U1 upon receiving a Gesture #2 from FIG. 5A. That is the same as a “caps shift” character from FIG. 4. Note that if the Shift State is U1 in FIG. 6, then one letter or a Backspace (BSP) returns the Shift State to LO. But, an additional Gesture #2 from FIG. 5A or a Case Shift button e.g., 15 advances the Shift State to Uppercase Always (UA.) The Case Shift button is a physical button. The Operating System software allows this Case Shift to be assigned to any of the buttons 15, 16, 17, 19, 20, or 21, according to the wish of the user.

In a similar fashion, a Num Shift button, e.g., programmed as button 20, advances the Shift State from LO in FIG. 6 to One Number (N1,) and if pressed again immediately, to Numbers All (NA.) If the user desires punctuation characters, they start at LO from FIG. 6 and press Case Shift 15. The user immediately press Num Shift 20. According to FIG. 6, the Shift State advances to Punctuation One (P1.) Notice that there is no Punctuation All state—only a Punctuation One. That is because punctuation marks are commonly created one at a time. One other aspect of FIG. 6 is the text string that appears in each box, such as “LOWER CASE” for LO, “ONE UPPER” for U1, etc. The computer device 26 has a Voice Chip 6 which creates vocalized feedback for operations performed by the user. The text strings given are vocalized out the Voice Chip at the moment of each Shift State change in FIG. 6.

To proceed from Gesture Numbers in FIG. 5A and FIG. 5B, first, the Shift State from FIG. 6 that the user has requested is considered. For LO, lowercase letters will be created. For U1 and UA, uppercase letters; for N1 and NA, numbers; for P1, punctuation marks. It will now be discussed how the control characters <space,> <backspace,> and <return> are handled. For LO, U1, UA, N1, and NA, it is the case that <space,> <backspace,> and <return> are offered to the user with the gesture shown in FIG. 4. Notice that in this embodiment, they are not offered to the user in P1 since the gestures for <space> and <return> are already taken, as “−” and “,”.

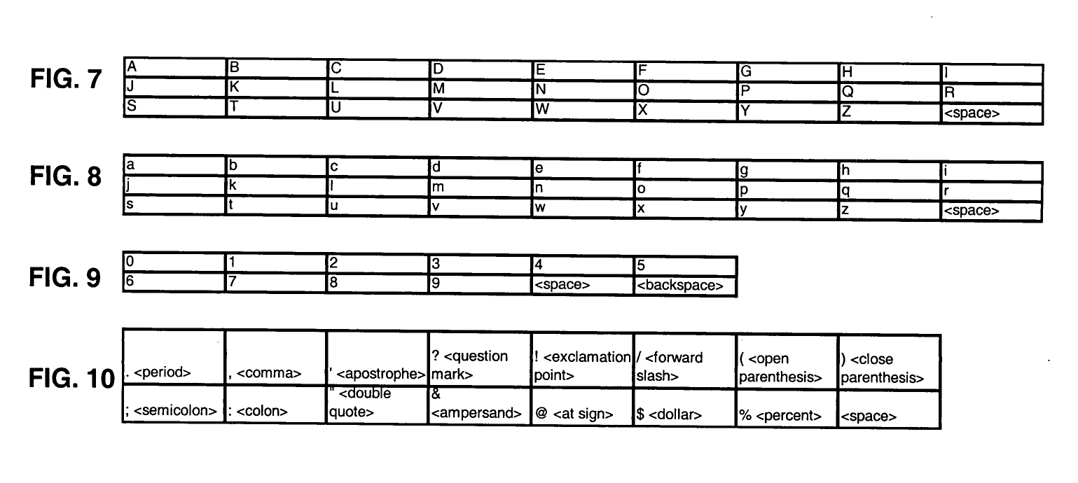

An alternate embodiment of the character recognizer called the Pointer Text approach works with the Select button 21. This alternative embodiment may be simpler for a user to learn and works as follows. Depending on the Shift State as previously described from FIG. 6, a table from FIG. 7, FIG. 8, FIG. 9, or FIG. 10 is selected as appropriate. FIG. 7 is selected for the U1 or U1 states; FIG. 8 is selected for LO, FIG. 9 is selected for N1 or NA, and FIG. 10 is selected for P1. Notice that the tables given are not a precise replacement of the functionality offered with the Unistroke recognizer from FIG. 4—for instance, <backspace> and <return> are not offered as part of the table for the alphabet in LO/U1/UA. For the implementation of FIG. 4, <backspace> and <return> are available as Gesture 8 and Gesture 13 in LO/U1/UA. The reason for the difference lies in the management of the table size and shape for Pointer Text. In order to make up for this difference, Application Software can assign <backspace> and <return> to specific physical buttons 16, 17, or 21, if desired, or offered as a menu choice.

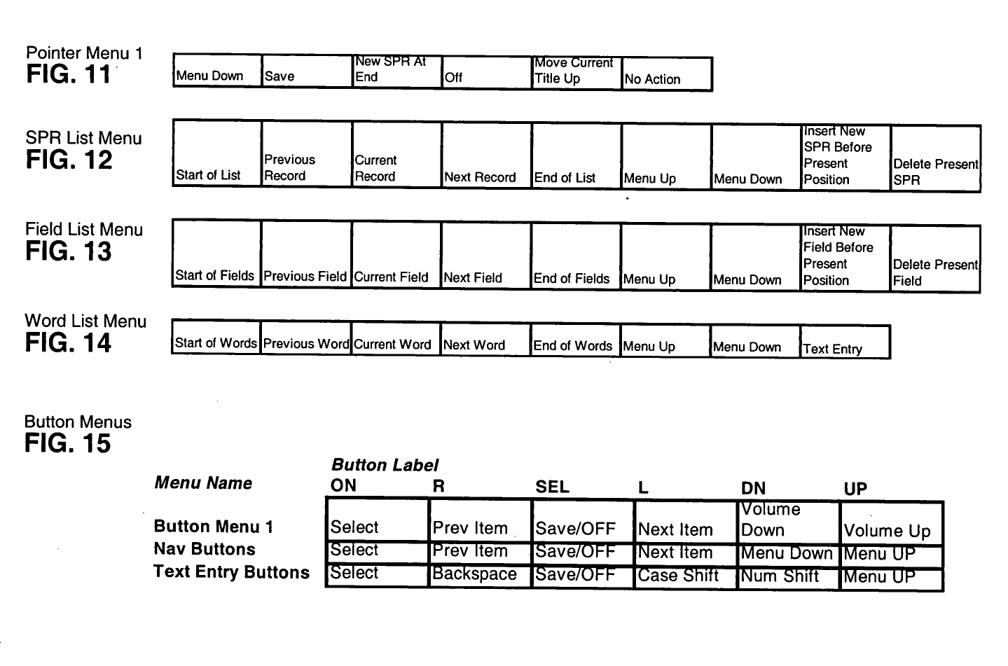

A Menu table in Pointer Text can be provided. Examples of Menus for use with Pointer Text are given in FIG. 11, FIG. 12, FIG. 13, and FIG. 14. They are a collection of commands that are made available to a user, organized as a table. In the examples given for FIG. 11, FIG. 12, FIG. 13, and FIG. 14, they are implemented as a table 1 row high and as many as 9 positions wide. Since the Y dimension is only 1 row high, variation in Y is not utilized in the selection. That means that all the selection is accomplished through the user in manipulation of the tilt in the X axis. The use of Pointer Text for Menus also indicates an additional worthwhile technique—the ability to select an entire phrase (ASCII string) with the system, which has been previously set up by the system designer.

From the selected table FIG. 7-FIG. 10, a mapping occurs from the X,Y Accelerometer 3 output to a position on the selected table. Generally, the table is mapped so that a reasonable operating range for the sensor covers the whole table. For example, FIG. 9 has 5×2 boxes. It may be that the Accelerometer 3 X & Y outputs range from 1.6v (1986 counts) to 2.0v (2482 counts) In the X direction, the delta counts from min to max is (2482−1986)=496 counts. This delta is divided by 5 boxes, or ˜99 counts. So in X, the first column of X from FIG. 9, which contains “0” and “6”, map to an Accelerometer 3 A/D value range of 1986 counts to (1986+99)=2085 counts. The A/D values for other boxes from FIG. 9 are similarly calculated. In Y, there are only 2 rows, so the A/D range gets divided in two parts, and
Y=1986 counts to 2234 counts=>lower row (“6”)
Y=2235 counts to 2482 counts=>upper row (“0”)

The calculations given are just one way of mapping accelerometer output values to a box on the given table. Other mapping functions could also be employed to give the same net effect, which is to resolve the X,Y Accelerometer 3 output to an entry in the current table for Pointer Text.

The Operating System through use of the Shift State Flow Chart as in FIG. 6 or the Application Software is responsible for selecting a Pointer Text table; examples of which can be seen in FIG. 7-FIG. 13. Exactly one table would be loaded at a time. Either a Pointer Text table or a Unistroke recognizer would be in effect; but not both at once. However, a single application could use Pointer Text for Menus and Unistroke recognizer for text entry, if so desired. Selection of a particular table entry with Pointer Text works as follows. The user prepositions the computer device 26 by tilting it in the direction that they think the desired table entry would be. They press the Select button 21. As soon as the Select button 21 is pressed, the contents of the Pointer Text table entry which corresponds to the current X, Y position is voiced by the Voice Chip 6. The Pointer Text algorithm keeps track of the X, Y position while the Select button 21 continues to be pressed. If the X, Y position advances to a new Pointer Text table entry, that entry gets voiced by the Voice Chip 6. While the Select Button continues to be held, a given Pointer text table entry will be voiced only once while the user's X, Y location is in the same box. When the user's X, Y location moves to another box on the Pointer Text table, then the contents of the new box is voiced. The timing is such that the Voice Chip 6 ceases whatever it is doing and immediately begins voicing the text for the Pointer Text box, within e.g. 50 ms of the user's X, Y location passing into the new Pointer Text box.

In this fashion, the computer device 26 provides audio feedback of the currently selected Pointer Text table position. The system continues to provide audio feedback indicating the users position in the Pointer Text table so long as the Select button is held. Upon release of the Select button, the Operating System “chooses” the Pointer Text box that is corresponds with the last X, Y location of the Accelerometer 3 before the Select button was released. The action taken at that point with the selected information is under control of the Application Software. Notice that either individual characters (FIG. 7-FIG. 10) can be selected; or menu commands (FIG. 11-FIG. 13) could be selected as well. Another option is short phrases for text input. For example, predefined strings (including multi-character inputs) for data input that a user can select; or selectable application commands.

In order to illustrate an example of an application designed for “eyes free” operation, the Sticky Pad Record (SPR) application will be discussed herein. It incorporates the text input innovations previously described (Unistroke input and/or Pointer Text,) along with Text-To-Speech audible feedback. It is an application designed to run on the computer 26 that supports one-handed, no-look operation.

It is referred to as the Sticky Pad Record application because it is intended to perform a similar function to the Post-It® notes. It is basically a recording medium for short bits of information or messages, which are intended for transient usage. The benefits that the computer device 26 bring to this usage is that the information is captured in electronic format immediately, onto a networked computer device capable of forwarding the information on to other computers via the wireless interface 8, and the information can be captured with just one hand without looking at the recording medium.

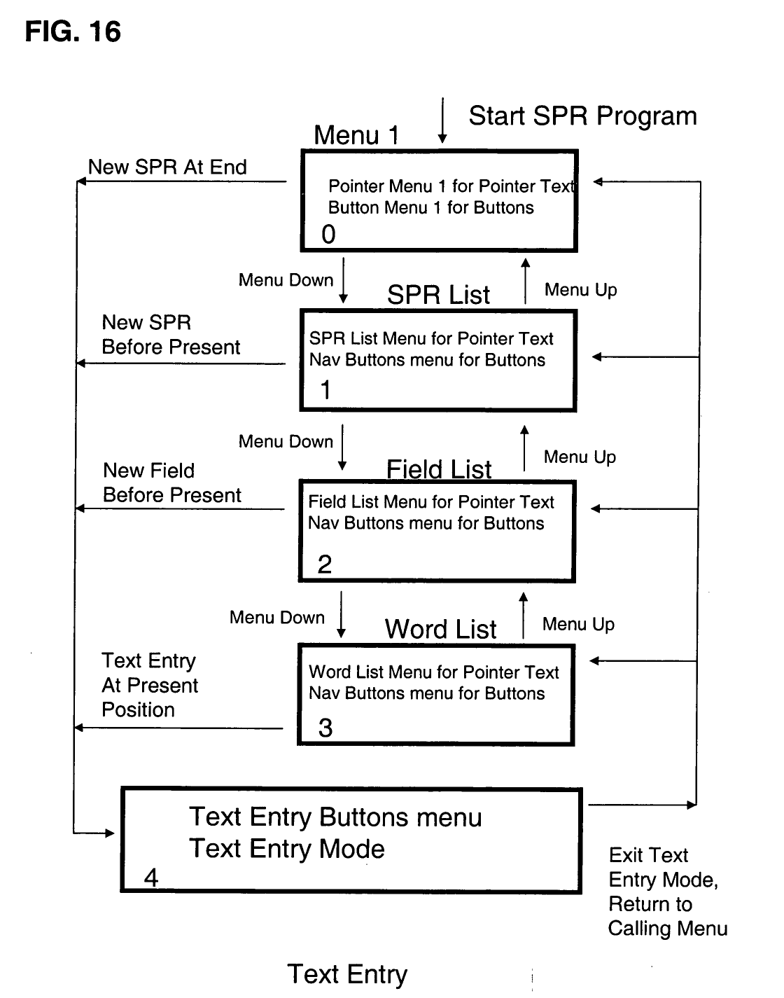

The Operating System launches the user into the SPR program after the processor 1 boots. In one embodiment, a Sticky Pad Record (SPR) consists of one or more fields. A Field is a short collection of words or a sentence. Associated with a Sticky Pad Record is a SPR Title, something which can be voiced to represent that SPR to the user. For purposes of illustrative discussion, five operational modes in the SPR application are presumed, each mode being represented by one of the five boxes in FIG. 16. The first mode is represented by Menu 1 in FIG. 16, which is the initial menu that is active when the user starts the SPR application. The second mode is represented by the SPR List menu from FIG. 16, which allows the user to browse through a list of Titles for all SPR's in the system. The third mode is represented by the Field List menu in FIG. 16, which allows the user to browse through a list of all fields in the current selected SPR. The fourth mode is represented by the Word List menu in FIG. 16, which allows the user to navigate through the words in the currently selected Field in the current SPR. The fifth mode is represented by the Text Entry Buttons menu from the bottom of FIG. 16. This is a Text Entry mode, in which it is possible to enter text at the present location in a SPR.

When the SPR program first starts, it is operating in the “Menu 1” mode, represented by FIG. 11. The table given in FIG. 11 is a table for use in the Pointer Text system, as described previously. That means that a user presses and holds the select button 21 to hear the Menu options as they navigate through them via tilting of the computer in the X direction. When the Select button 21 is released, the Menu choice in accordance with the current X angle will be executed. The leftmost menu choice in FIG. 11 is Menu Down. When selected, it will change the Table used by the Pointer Text system to FIG. 12. However, in this “Menu 1” mode, the device buttons 15-21 are active. FIG. 15, row 1 (“Button Menu 1”) indicates the 6 functions assigned to the 6 buttons in this mode. Per FIG. 15 (top row), this button, labeled “ON”, is assigned to the Select function. This is the same Select function as has been described previously, associated with the Select button 21. The next button on the device is 20, labeled “R”. The second box in the first row of FIG. 15 indicates that while in Button Menu 1, this button is associated with the Prev Item function. There are special implications when this button 20 or when button 17 are used in this mode. While in the “Menu 1” mode, represented by FIG. 11, if either button 20 or button 17 are pressed, the user is indicating that they would like to navigate the menu via buttons and not with the Accelerometer 3. Therefore, in “Menu 1” mode, if either button 20 or button 17 is pressed, then FIG. 11 “Pointer Menu 1” will be navigated via the use of button 20 for Prev Item, which means to change the selected menu item one box to the left on FIG. 11, or button 17 for Next Item, which means to change the selected menu item one box to the right on FIG. 11. As the selected menu item is changed by the use of these buttons, it is voiced via the Voice Chip 6 so that the user is aware of which menu choice is selected. However, the given menu choice is not executed until the user then taps the Select button 21. However, if neither button 20 nor button 17 is ever pressed while in this “Menu 1” mode, but rather the user presses the Select button 21 initially, then the menu navigation is through the Pointer Text mechanism previously described, which is to say that it is controlled by the Accelerometer 3 input, and whichever box from FIG. 11 is “pointed” to when the Select button 21 is released is executed. That is why there is a “No Action” menu selection (rightmost box on FIG. 11.) The user could select that item so that no action is executed when the Select button 21 is released.

FIG. 16 is the menu state flow diagram. It indicates the different menus available in the illustrative SPR application. The SPR program has an internal variable which indicates which SPR on the device is selected for operations. This internal variable is called the SPR Selected Register.

The leftmost table entry for FIG. 12 is Start of List, which instructs the SPR program to position the SPR Selected Register at the first SPR record in Flash memory 2. When this Menu choice is executed, the Voice Chip 6 will voice “START OF SPR LIST,” pause, and voice the Title of the selected SPR. The second from the rightmost table entry for FIG. 12 is End of List. When this Menu choice is selected, the SPR program to position the SPR Selected Register to the last SPR record in Flash memory 2. When this Menu choice is executed, the Voice Chip 6 will voice “END OF SPR LIST,” pause, and voice the Title of the selected SPR.

Another Menu command in FIG. 12 is Previous Record. When executed, it will increment the SPR Selected Register to the next available SPR record in Flash memory 2. If the SPR Selected Register was already at the last SPR record in Flash memory 2, the Voice Chip 6 will voice “END OF SPR LIST,” pause, and voice the Title of the selected SPR. If it was not already at the last SPR record in Flash memory 2, the Voice Chip 6 will voice “SPR NUMBER,” the index number of the SPR record, and then voice the Title of the selected SPR. Another Menu choice from FIG. 12 is Previous Record. When executed, it will decrement the SPR Selected Register to the SPR record which has a lower index than the currently selected one. If the SPR Selected Register was already at the first SPR record in Flash memory 2, the Voice Chip will voice “START OF SPR LIST,” pause, and voice the Title of the selected SPR. If it was not already at the first SPR record in Flash memory 2, the Voice Chip 6 will voice “SPR NUMBER,” the index number of the SPR record, and then voice the Title of the selected SPR. Another Menu command in FIG. 12 is Current Record. When executed, the Voice Chip 6 will voice “SPR NUMBER,” the index number of the SPR record, and then voice the Title of the selected SPR.

Another Menu choice from FIG. 12 is Menu Up. This selection can be also seen pictorially in the arrows exiting the “SPR List” box in FIG. 16. When the “Menu Up” menu choice is activated, it navigates the menu to the “Menu 1” level, as illustrated in FIG. 16. When the “Menu Down” menu choice is activated, the menu level is changed to the “Field List” level, as indicated in the box on FIG. 16. These menu choices allow the user to navigate through the different menu modes.

It should be noted that there are some additional Button functions, since in FIG. 12 SPR List menu mode, the Button Menu that is in effect is the Nav Button menu. This is different than Button Menu 1.

By utilizing these Menu commands from FIG. 12, a user can navigate through the Titles of the SPR's present in Flash memory 2.

While operating at the Menu level illustrated by FIG. 11, there is a mapping of certain functions to the Buttons 15, 16, 17, 19, 20, and 21.

The present invention has been illustrated and described with respect to specific embodiments thereof, which embodiments are merely illustrative of the principles of the invention and are not intended to be exclusive or otherwise limiting embodiments.

In accordance with the foregoing description of illustrative embodiments of the present invention, and illustrative variations or modifications thereof, it may be appreciated that the present invention provides many features, advantages and attendant advantages, all or any one or more of which may not necessarily be incorporated in any particular embodiment of the present invention.

Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages. It is further noted that the terms and expressions have been used as terms of description and not terms of limitation. There is no intention to use the terms or expressions to exclude any equivalents of features shown and described or portions thereof. It is therefore intended that the present invention is not limited to the disclosed embodiments but should be defined in accordance with the claims that follow.

I claim:

1. A handheld computing device, comprising:
a motion sensing circuit that measures device motion and generates corresponding output signals which include a signals representative of a character gesture;
a bounding circuit which includes a bounding signal; and
a processor, in communication with said motion sensing circuit and said bounding circuit, which implements a recognition algorithm which processes the bounding signal and said character gesture to resolve a predetermined symbol.

2. The device of claim 1 wherein the bounding circuit includes recognition of “Virtual Button Gesture” in the motion sensing circuit signal as a delimiting operator to demarcate the start or end of said character gesture.

3. The device of claim 1 wherein the bounding circuit includes a user-operated switch and said bounding circuit recognizes an input from said switch as a delimiting operator to demarcate the start or end of said character gesture.

4. The device of claim 1 further comprising a circuit for Text-To-Speech (TTS) conversion, which circuit includes Voice Chip.

5. The device of claim 1 further comprising one or more physical buttons, in addition to said user actuated delimiting switch, each button having a programmable function.

6. The device of claim 1 further comprising an expansion interface, which allows additional computing resources to be added to the system, which could consist of one or more additional processors connected to the expansion interface.

7. The device of claim 1 further comprising circuits to support wired networking.

8. The device of claim 7 wherein the wired networking circuit includes a Universal Asynchronous Receiver/Transmitter (UART) port, with circuits to implement the EIA/RS232 standard, for the purpose of networking with other computing devices.

9. The device of claim 1 further comprising circuits for wireless networking.

10. The device of claim 9 wherein the wireless networking circuit includes a Bluetooth for the purpose of networking with other computing devices.

11. The device of claim 1 further comprising circuits and a connector to support connection to a wired handsfree unit.

12. The device of claim 1 further comprising circuits and a radio interface to support the connection to a wireless handsfree unit.

13. The device of claim 1 further comprising a power supply.

14. The device of claim 13 wherein said power supply includes batteries to power the device.

15. The device of claim 14 wherein said power supply includes circuits to recharge the batteries for the case of batteries which are rechargeable.

16. The device of claim 13 wherein said power supply includes a circuit and connector for the power to be provided from an external power supply.

17. The device of claim 1 wherein the motion sensing circuit includes a tilt sensor, whose sensitivity is adequate to measure the acceleration from the gravity vector.

18. The device of claim 1 wherein the motion sensing circuit is a mechanism comprising:
a platform which is affixed in some way to a person while they are using the computing device, and
a plurality of sensors, such as potentiometers or the like, which are used to measure the tilt in one or more dimensions, which measure the position of the computing device with respect to the aforementioned platform.

19. A method of gesture recognition, comprising the steps of:
measuring motion in 3 dimensional space;
generating output signals corresponding to said measured motion which include signals representative of a character gesture;
generating a bounding signal; and
processing the bounding signal and said character gesture to resolve a predetermined symbol.

20. The method of claim 19 wherein the step of generating the bounding signal includes recognition of “Virtual Button Gesture” in the measured motion signal as a delimiting operator to demarcate the start or end of said character gesture.

21. The device of claim 19 wherein the step of generating the bounding signal comprises use of a user-operated switch to provide a delimiting operation to demarcate the start or end of said character gesture.

22. A computer readable medium programmed with an algorithm to implement the method of claim 19.

23. A computer readable medium programmed with an algorithm to implement the method of claim 20.

24. A computer readable medium programmed with an algorithm to implement the method of claim 21.
